(19) United States
(12) Patent Application Publication
(10) Pub. No.: US 2002/0171534 A1
(43) Pub. Date: Nov. 21, 2002

(54) IDENTIFICATION SYSTEM

(76) Inventor: TERRENCE KEITH ASHWIN, RANDPARK RIDGE (ZA)

Correspondence Address: LADAS & PARRY, 26 WEST 61ST STREET, NEW YORK, NY, 10023, US

(21) Appl. No.: 09/260,286

(22) Filed: Mar. 2, 1999

(30) Foreign Application Priority Data
Mar. 2, 1998 (ZA) 98/1726

(51) Int. Cl. H04Q 5/22

(52) U.S. Cl. 340/10.3

(57) ABSTRACT

A method of communicating data from a transmitter 12 to receiver 26 is provided. The method includes providing the transmitter 12 with a counter 16 and data to be communicated, and periodically adjusting a count of the counter 16 to generate modified data which is then transmitted. Typically, the count is incremented each time a signal is transmitted by the transmitter 12 which is typically in the form of an electronic tag. The invention thus extends to a transmitter 12 which includes storage means 14 for storing unique identification data for identifying the tag, and a counter 16 having a current count which is periodically adjusted in use. Further, the invention extends to a monitoring system 10 which includes a plurality of transmitters 12 as herein before described and a receiver 26 including analysis means 30 for analysing the transmitted signal 15.

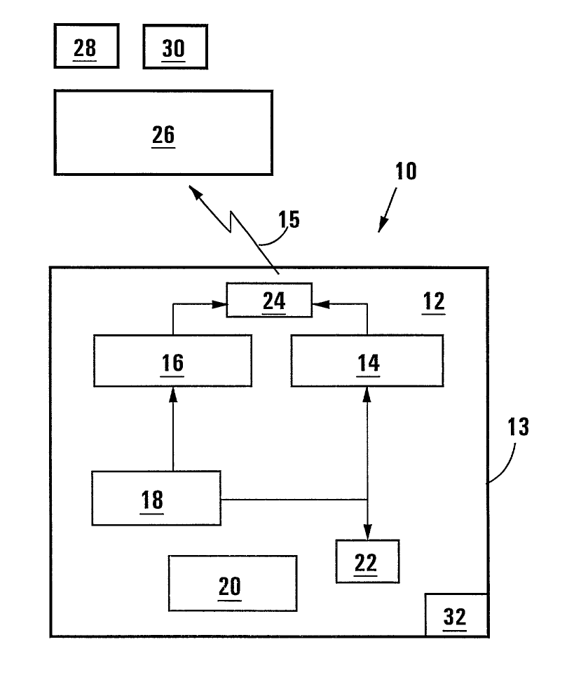

THIS INVENTION relates to an identification system. It also relates to a method of identifying a transmitter and to a transmitter for use in the system and method.

Electronic tags are sometimes attached to an object and are used in conjunction with a reader device to identify that object passing through a zone or being present at the zone at a particular time. When the electronic tag is attached to or carried by a person such as a security guard, the reader device can be used to identify that the person has been or is at a particular location at a particular time.

In accordance with the invention, there is provided a method of identifying a transmitter communicating data to a receiver, the method including

providing the transmitter with a counter and data to be communicated;

periodically adjusting a count of the counter;

generating modified data by modifying the data dependent upon the count; and

transmitting the modified data to the receiver.

The method may include

storing a reference count in the transmitter prior to use;

periodically adjusting the count at a predetermined time interval to define a current count; and

calculating at the receiver an age of the transmitter by multiplying the current count and the predetermined time interval and comparing the result with the reference count.

The method may include sensing when tampering with the transmitter occurs and reseting the reference count when tampering is sensed. Instead, the method may include, storing the reference count in storage means of the transmitter in a permanent fashion thereby to inhibit subsequent variation of the count.

The count may be adjusted each time modified data is transmitted and the receiver may determine the predetermined time interval by monitoring the interval between successive transmissions of the transmitter. The count may be adjusted by incrementing the count. It will be appreciated that the counter could instead be preset with any predetermined number and decremented or incremented by a fixed amount at the periodic time intervals.

The method may include evaluating the current count received from the transmitter at a particular point in time with reference to a prior count which defines an historical count, and monitoring when a difference in the count is outside of a predetermined range.

The data may be unique identification data for uniquely identifying the transmitter.

The method may include encapsulating the transmitter in a sealed housing prior to use to define an electronic tag resistant to tampering. Further, the method may include encrypting the data and thereafter manipulating the data dependent upon the count.

Further in accordance with the invention, there is provided an identification system, which includes

a plurality of transmitters, each transmitter including unique identification data for identifying the transmitter and a counter having a count which is periodically adjusted, the unique identification data being operatively modified by the count to generate modified data included in a transmitted signal; and

a receiver including analysis means for analysing the transmitted signal, the analysis means being operable to extract the count and the unique identification data from the transmitted signal thereby to identify the transmitter.

The system may include storage means for storing at least historical data of the count received from the transmitter, the analysis means being operable to compare a current count received with the historical data and generate a status signal when a difference in the count is outside a predetermined range.

### In certain embodiments, the system includes an alarm device for selectively generating an alarm in response to the status signal.

When the count in the counter is adjusted at the predetermined time intervals, differences in the count held by the counter can then be used to calculate elapsed time between successive or particular interrogations of the tag by the receiver.

The system may include triggering means for triggering of the count. The triggering means may be selectively adjustable or may be influenced by the type of identification data stored in the tag. In this way a tag having particular identification data can only validly have a particular count or a count within a particular range at a particular time. Thus, if an attempt is made to introduce a counterfeit tag into an identification system, the counterfeit tag can be detected as being counterfeit even if the identification data stored by such counterfeit tag is valid but the count does not fall within the predetermined valid range of counts.

The transmitter may include encoding means for encoding the unique identification data prior to modifying the count. Typically, the transmitter is in the form of an electronic tag operable to transmit the transmitted signal in a wireless fashion.

When the system is, for example, used to monitor or identify objects or assets, the transmitter preferably includes attachment means for attaching the tag to the object to be monitored e.g. a laptop computer or the like. The attachment means may be configured fixedly to attach the tag to the object, the tag including sensing means for sensing tampering with the tag and modifying the count when tampering is sensed.

In certain embodiments of the invention, the transmitter is in the form of an computer terminal operable to transmit the transmitted signal via a telecommunication channel. Thus, when conducting e-commerce, the vendor equipped with a receiver may identify the purchaser and, in response to analysis of the unique identification data, approve or validate the transaction.

Still further in accordance with the invention, there is provided a transmitter which includes

storage means for storing unique identification data for identifying the transmitter; and

a counter having a current count which is periodically adjusted in use, the unique identification data being modified dependent upon current count to generate modified data included in its transmitted signal.

The transmitter may include a reference count which is stored in the storage means prior to use and which is periodically adjusted at a predetermined time interval to define the current count thereby to provide an indication of the age of the transmitter. When the tag is interrogated, the count in the counter may be transmitted together with the time interval stored in the storage means. In such an application, the count held by the counter can be used to identify the number of times that the count has been adjusted and by multiplying the count by the time interval in the time storage means, the age of the tag can be calculated. This information can then be used to as a yardstick for deciding when a battery powering the electronic tag has reached an end of its useful life and hence may fail.

In a preferred embodiment of the invention, the transmitter includes sensing means for sensing when tampering with the transmitter occurs and is operable to reset the current count to the reference count when tampering is sensed.

In certain embodiments, the transmitter includes storage means for storing the reference count in a permanent fashion thereby to inhibit subsequent variation of the count.

The current count may be adjusted each time modified data is transmitted thereby to enable a receiver to determine the predetermined time interval by monitoring the interval between successive transmissions of the transmitter. Preferably, the count is adjusted by incrementing the count, typically by 1.

The data is advantageously unique identification data for uniquely identifying the transmitter and thus an object or person with which it is associated. Accordingly, the transmitter may be in the form of an electronic tag operable to transmit the transmitted signal in a wireless fashion.

The transmitter preferably includes attachment means for attaching the tag to an object to be monitored. The attachment means may be configured fixedly to attach the tag to the object, the tag including sensing means for sensing tampering with the tag and modifying the count in response thereto.

The tag is conveniently in the form of a programmable tag allowing storage in the storage means of unique identification data to permit unique identification of a person or object or particular type of object by way of a unique code.

The tag may be a portable tag which can be carried by a person. Additionally or instead, the tag may have attachment means to permit attachment, e.g. permanent attachment, to a particular object.

The tag may be in the form of an active tag having a battery for powering it and having a radio frequency transmitter for transmitting a signal containing the identification data and the value of the count held by the counter.

An embodiment of the invention is now described, by way of example, with reference to the accompanying diagrammatic drawing in which a schematic block diagram of an identification system in accordance with the invention is shown.

Referring to the drawing, reference numeral 10 generally indicates an identification system, the main component of which is a transmitter in the form of an electronic tag 12, also in accordance with the invention. The tag 12 is encapsulated in a, preferably sealed, housing 13 and has storage means 14 which is programmable to permit storing of unique identification data associated with a particular object, e.g. a personal computer, or a particular person.

The tag 12 further includes a counter 16 and triggering means 18, e.g. in the form of a clock pulse generator including an R-C circuit. In the embodiment depicted in the drawings, a reference count of O is stored in the storage means 14 as soon as power is applied to the tag by insertion of the battery 20 (before encapsulation). The triggering means 18 is arranged periodically or cyclically to trigger the counter 16 and adjust the count to define a current count. In the embodiment depicted in the drawings, the count is adjusted by incrementing the count but it is to be appreciated that the count may also be decremented. Further, in other embodiments, the reference count may be set at a non-zero value known to a user of the tag 12, the reference count may be permanently fused or programmed into the tag 12 in a permanent fashion thereby to prevent subsequent variation of the count, or may be selectively re-programmed into the tag 12 on a non-permanent basis selectively to allow subsequent variation of the count.

The triggering means 18 can also be programmable so as selectively to vary the time interval between successive triggering of the counter 16. Typically, the triggering means 18 of each different tag 12 triggers the counter 16 at a slightly different predetermined time interval to reduce signal interference between tags 12 located in proximity to each other. For example, the predetermined time interval for one tag 12 may be 1 s and for a second tag 12 about 1.001 s, and so on.

In certain embodiments, the tag 12 further includes time storage means 22 (which could if desired be incorporated in the storage means 14 and be an R-C circuit or the like) for defining the time period between successive triggering of the counter 16. Preferably, the current count is incremented each time the transmitter transmits data. Accordingly, the reader 26 may monitor the time interval between successive transmissions thereby to determine the predetermined time interval.

The tag 12 further includes a radio frequency transmitter 24 which transmits the unique identification data stored in the storage means 14 together with the count held by the counter 16 at a predetermined time interval stored in the time storage means 22. In particular, the tag 12 may include an electronic chip which defines several of its various components. The chip includes a processor which encodes the unique identification data and modifies or manipulates the identification data dependent upon the current count. Accordingly, the data transmitted by the tag 12 is constantly changing dependent upon the value of the current count and may thus enhance encryption.

In use, the tag 12 periodically transmits a transmitted signal 15 which changes with each change in count. A reader 26 having a suitable radio frequency receiver can then be used receive the transmitted signal 15 and process the signal to extract the count and the unique identification data. It will be appreciated that the reader 26 can be of a variety of types and does not necessarily require intelligence.

The tag illustrated can be used in a variety of applications. For example, the current count held by the counter 16, when multiplied by the predetermined time interval can given an indication of the age of the tag 12. Typically, a long life battery 20 is used in the tag 12 but, from experience, such a battery may be expected to fail after a particular period, such as 5 years. The count read by the reader 26 can then be used as a yardstick to determine the remaining working life of the battery 20 in a particular tag 12.

In another application, if the tag 12 is carried by a security guard, the current count read by the reader 26 at a particular time can be stored in a database to define an historic count. When the tag 12 carried by the security guard is read at a later stage, the difference in the current count and the historic count can be used to determine elapsed time between the successive reads by the reader 26. In effect, this can be used to monitor the security guard as the security guard moves from location to location and give an indication in real time when the security guard was at a particular location.

The addition of the counter 16 to the tag 12 also permits detection of a counterfeit tag which may be introduced into the identification system 10. By monitoring valid tags used in the identification system 10, and by storing the current count for each tag in a database, typically forming part of a personal computer, to define an historic count, if a counterfeit tag having valid identification data is read by the reader 26 and a count is absent or if the current count is below or out of a predetermined range form the historic count stored previously for the valid tag 12, the system 10 can detect that the tag is a counterfeit tag. Accordingly, the system 10 may include an alarm 28 responsive to a status signal from comparator 30 which defines analysis means for analysing the signal 15. The comparator 30 may be defined by a personal computer or the like and generate the status signal in response to a comparison between the current count and the historic count.

The tag 12 can also be used to monitor the age of a vehicle by being permanently attached to the vehicle, with the storage means 14 containing identification details of the vehicle which are included in the unique identification data. The tag 12 can be periodically updated with an odometer reading of the vehicle, e.g. during a service. If an attempt is made to reduce the odometer reading which may thus define the current count, this can be detected by comparison with a historic odometer reading. Also if identification data, such as a chassis number, engine number, vehicle registration number, or the like is changed, this can be detected by comparison of the data held by the tag 12 with historic data.

In other embodiments of the invention, the identification system 10 may be used to identify a participant, for example, in e-commerce. In this embodiment, the tag 12 or a variation thereof is installed in a personal computer or PC and the receiver 26 is located at a vendor vending goods or services. Communication may then not be over a wireless network but via a hardwired network e.g. a telecommunications network. The unique identification data modified by the count may then identify or validate a financial transaction which a user at a remote terminal wishes to effect.

In yet further application of the invention, the tag 12 is fitted to a personal computer (PC). The unique identification data typically includes a serial number of the (PC).

1. A method of identifying a transmitter communicating data to a receiver, the method including
providing the transmitter with a counter and data to be communicated;
periodically adjusting a count of the counter;
generating modified data by modifying the data dependent upon the count; and
transmitting the modified data to the receiver.

2. A method as claimed in claim 1, which includes
storing a reference count in the transmitter prior to use;
periodically adjusting the count at a predetermined time interval to define a current count; and
calculating at the receiver an age of the transmitter by multiplying the current count and the predetermined time interval and comparing the result with the reference count.

3. A method as claimed in claim 2, which includes sensing when tampering with the transmitter occurs and reseting the reference count when tampering is sensed.

4. A method as claimed in claim 2, which includes storing the reference count in storage means of the transmitter in a permanent fashion thereby to inhibit subsequent variation of the count.

5. A method as claimed in claim 2, in which the count is adjusted each time modified data is transmitted and the receiver determines the predetermined time interval by monitoring the interval between successive transmissions of the transmitter.

6. A method as claimed in claim 1, in which of the count is adjusted by incrementing the count.

7. A method as claimed in claim 1, which includes evaluating the current count received from the transmitter at a particular point in time with reference to a prior count which defines a historical count, and monitoring when a difference in the count is outside of a predetermined range.

8. A method as claimed in claim 1, in which the data is unique identification data for uniquely identifying the transmitter.

9. A method as claimed in claim 1, which includes encapsulating the transmitter in a sealed housing prior to use to define an electronic tag resistant to tampering.

10. A method as claimed in claim 1, which includes encrypting the data and thereafter manipulating the data dependent upon the count.

11. An identification system, which includes
a plurality of transmitters, each transmitter including unique identification data for identifying the transmitter and a counter having a count which is periodically adjusted, the unique identification data being operatively modified by the count to generate modified data included in a transmitted signal; and
a receiver including analysis means for analysing the transmitted signal, the analysis means being operable to extract the count and the unique identification data from the transmitted signal thereby to identify the transmitter.

12. A system as claimed in claim 11, which includes storage means for storing at least historical data of the count received from the transmitter, the analysis means being operable to compare a current count received with the historical data and generate a status signal when a difference in the count is outside a predetermined range.

13. A system as claimed in claim 12, which includes an alarm device for selectively generating an alarm in response to the status signal.

14. A system as claimed in claim 11, in which the transmitter includes encoding means for encoding the unique identification data prior to modifying the count.

15. A system as claimed in claim 11, in which the transmitter is in the form of an electronic tag operable to transmit the transmitted signal in a wireless fashion.

16. A system as claimed in claim 15, in which the transmitter includes attachment means for attaching the tag to an object to be monitored.

17. A system as claimed in claim 16, in which the attachment means is configured fixedly to attach the tag to the object, the tag including sensing means for sensing tampering with the tag and modifying the count when tampering is sensed.

18. A system as claimed in claim 11, in which the transmitter is in the form of an computer terminal operable to transmit the transmitted signal via a telecommunication channel.

19. A transmitter which includes storage means for storing unique identification data for identifying the transmitter; and a counter having a current count which is periodically adjusted in use, the unique identification data being modified dependent upon current count to generate modified data included in its transmitted signal.

20. A transmitter as claimed in claim 19, which includes a reference count which is stored in the storage means prior to use and which is periodically adjusted at a predetermined time interval to define the current count thereby to provide an indication of the age of the transmitter.

21. A transmitter as claimed claim 20, which includes sensing means for sensing when tampering with the transmitter occurs and is operable to reset the current count to the reference count when tampering is sensed.

22. A transmitter as claimed in claim 20, which includes storage means for storing the reference count in a permanent fashion thereby to inhibit subsequent variation of the count.

23. A transmitter as claimed in claim 19, in which the current count is adjusted each time modified data is transmitted thereby to enable a receiver to determine the predetermined time interval by monitoring the interval between successive transmissions of the transmitter.

24. A transmitter as claimed in claim 19, in which of the count is adjusted by incrementing the count.

25. A transmitter as claimed in claim 19, in which the data is unique identification data for uniquely identifying the transmitter.

26. A transmitter as claimed in claim 25, in which the transmitter is in the form of an electronic tag operable to transmit the transmitted signal in a wireless fashion.

27. A transmitter as claimed in claim 26, in which the transmitter includes attachment means for attaching the tag to an object to be monitored.

28. A transmitter as claimed in claim 27, in which the attachment means is configured fixedly to attach the tag to the object, the tag including sensing means for sensing tampering with the tag and modifying the count in response thereto.
